(19) United States
(12) Patent Application Publication
(10) Pub. No.: US 2006/0026498 A1
(43) Pub. Date: Feb. 2, 2006

(54) Systems and methods for controlling report properties based on aggregate scope

(75) Inventors: Christopher Alan Hays, Monroe, WA (US); Jason D. Carlson, Redmond, WA (US); Fang Wang, Bellevue, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/903,306

(22) Filed: Jul. 30, 2004

(51) Int. Cl. G06F 17/30

(52) U.S. Cl. 715/503

(57) ABSTRACT

A plurality of scope declarations can be provided to delineate various portions of any data structure, such as a matrix, a table, or a chart. Some scope declarations may correspond to portions of a horizontal axis, or columns, while other scope declarations may correspond to portions of a vertical axis, or rows. Thus, the aggregate scope at any given location within a data structure may vary, depending on which scope declarations overlap at the given location. Properties can be set for a location of a data structure based on this aggregate scope, thereby providing increased control flexibility.

### CROSS-REFERENCE TO RELATED APPLICATIONS

This application is related to co-pending U.S. application Ser. No. 10/400,734, filed on Mar. 27, 2003, entitled “Defining a report based on data regions and including custom data in a report definition,” and identified by Attorney Docket No. MSFT-1530/302616.1; and to co-pending U.S. application Ser. No. 10/875,832, filed on Jun. 23, 2004, entitled “Systems and Methods for Flexible Report definitions Including table, Matrix, and hybrid designs,” and identified by Attorney Docket No. MSFT-3483/307869.01.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2004, Microsoft Corp.

### FIELD OF THE INVENTION

The present invention relates to data reporting, and more particularly to techniques for flexible control over the properties of report data structures.

### BACKGROUND OF THE INVENTION

In any enterprise, data regarding aspects thereof is accumulated over time. This data can be used to report the status of the enterprise. For example, with regard to a sales enterprise, sales data can be accumulated pertaining to each sale of a product, including the salesman, the customer, the region of the salesman, the region of the customer, the amount of the sale, the quantity of the product sold, the date of the sale, the date of the delivery of the sold product, and so on. Based on such sales data, then, it may be that a report is generated that details sales by year, by month, by customer by year, by product by quarter, by salesman by delivery date, by region by week, etc.

The data that populates a report will typically be accumulated in a data source, such as a database. A data source, as the term is used here, is a storehouse for digitally recorded data. In order to filter the data in a data source into properly organized columns and rows for a report, a report designer may specify, in a report definition, the particular data that is desired from a data source. For example, a report designer might specify that he wants a “salesman name” in the first column of a report.

The report designer may then write a program that recognizes the field indicated for the first column of a report definition (salesman name), queries a data source for all salesman names, and places them, one after the other, in the first column of a report. Instead of writing his own program to carry out this task, the report designer may use commercial software that provides this function. Such software may allow a report designer to simply specify, in a report definition, a type of data he wants in the various columns and/or rows of a report. The commercial software will then automatically analyze the report definition, query a database, and place the desired data in a report.

FIG. 1b depicts exemplary report processing software 160 for populating a report definition 150 with appropriate data. The report processing software 160 may comprise a plurality of data extensions 161 for properly interpreting data stored in any of a plurality of data sources 170, 171. The report processing software 160 may also comprise a number of rendering extensions 162. The rendering extensions 162 convert generated reports into appropriate file formats, e.g., Hyper-Text Markup Language (HTML) 180, Extensible Markup Language (XML) 181, or some other file format 182. A process (not shown) capable of reading the formatted output files 180, 181, 182 can then display the report through a Graphic User Interface (GUI). In summary, a report definition 150 is used by the report processing software 160 to identify the data to be gathered from data sources 170, 171 and compile the data into a properly structured report. The software 160 may generate a report in any file format 180, 181, 182. This process is also described in U.S. patent application Ser. No. 10/400,734, which is hereby incorporated by reference in its entirety.

Reports may include a variety of data structures. An example of one such structure, a matrix, is provided in FIG. 1a. A matrix is characterized by columns arranged along a horizontal first axis 100 and rows arranged along a vertical second axis 110. These columns and rows can be dynamic or static. Static columns and rows are characterized by a one-to-one relationship between the report definition and the output report. Dynamic columns and rows are abstractly identified in a report definition, such that they can be expanded as necessary by report generating software to adequately present greater or lesser amounts of report data. For example, as time goes on, the data in columns 120 and 121 may expand to include subsequent years 2003 and 2004. Additional columns can be added automatically to provide such additional data. This allows report designers to re-use a single report definition from year to year.

A matrix data structure can contain nested column/row groups, such as the “burger” and “pizza” products from FIG. 1a that are nested in the “food” category. A matrix data structure can also contain header and footer columns and rows. For example, FIG. 1a gives a header row with column identifiers such as 120 and 121, and a footer row for grand totals at the bottom row of the matrix. In addition, nested footers in FIG. 1a provide subtotals within each category. These header and footer rows typically, but not necessarily, contain some information that is different from the non-header/footer rows, and that serves to describe or summarize the data in the non-header/footer rows.

FIG. 1a illustrates a prior art matrix that allows for control of properties on a column-by-column or row-by-row basis. Thus, report designers can specify any number of properties for an entire column or entire row. Because these properties are applied to an entire row and/or column, they can be conceptualized as a single function corresponding to all cells in a row e.g., 132, or column, e.g., 120a.

For example, if a report designer wants to present a both a blue background and a sum of product sales in row 130, he can specify that each cell of row 130 contains both, 1. a blue background, and 2. a function that returns a sum of any above two cells. In the example provided, this works well enough for some cells, such as the first and second detail cells in row 130. The first detail cell in row 130 will present a blue background and a total of burger and pizza sales for the first half of 2001. The second detail cell in row 130 will present a blue background and a total of burger and pizza sales for the second half of 2001. However, note the problem that occurs when we arrive at the intersection of row 130 and the year 2001 Average (Avg.) column. Consumers of the report may be confused about the information in this cell. It may not be clear whether it should contain an average, or a total.

The technique currently available to solve the problem presented in FIG. 1a falls short of what might be desired. Report designers can specify that a column or row overrides, or does not override, the rows or columns, respectively, that it crosses. In FIG. 1a, row 130 overrides column 120a. Thus, the properties specified for entire row 130 may be presented in the third detail cell of row 130. The properties of column 120a, are not presented in the cell because 120a is overridden by 130. Similarly, the properties of column 122 override the properties of row 130 and row 131. Various other overrides are also illustrated in FIG. 1a. For example, column 120a is a column with single function for deriving properties of the data structure for locations within column 120a. The function in column 120a, whatever it may be, may be overridden by the function in rows 130, 131, and 132. Similarly, a function in column 122 overrides the function in rows 130 and 131, but is overridden by the function in column 132. Row 130 contains a single function for deriving properties of the data structure for locations within row 130, which, as indicted by the use of shading in the illustration, overrides the function in column 120 (as well as the other, unidentified subtotal column. However, the function in row 130 is overridden by the function in column 122. Overrides 120a, 122.

Using techniques such as giving a row or column a background color may help to clear confusion about what data is presented in the matrix. For example, the blue background for row 130, which overrides a hypothetical red background of column 120a, may suggest that the data in all cells with a blue background is a total of the above two cells. More specifically, the consumer is led to conclude the data in the third detail cell of row 130 is a total, because the row contains a blue background similar to the other cells of 130. This is an imperfect fix, however, for a variety of reasons. Regardless of background color, consumers of such a matrix may not find the information in such a cell to be useful. A report designer may prefer to leave such a cell blank, or to provide some other information therein.

To leave a cell in row 130 blank is to provide a non-uniform function for the cells of the row 130. Such a non-uniform function for a row or column is possible, albeit cumbersome, using present techniques. It entails entry of specific values into specific cells in a report definition. In other words, a report definition for such a report would include individual entries for each of the detail cells in row 130. Such a report definition is more complex and cumbersome to manage and modify. Alternatively, the report definition can include more complicated functions for entire rows and columns. For example, row 130 could be governed by a function that specifies, “if the above two cells have a white background, calculate and display a total, but if they have a red background, leave the cell blank.” Once again, this is an imperfect fix, because the report definition becomes more complicated, and because such complex functions may become difficult to manage in large matrices with various kinds of data. Simpler techniques for flexibly controlling report properties are desirable.

Other examples of data structures that may be used in reports are tables and charts. Each of these data structures may present similar problems of property control in different contexts. A traditional table is simpler than a matrix, in that rows may be static or dynamic, but columns are only static. Tables, matrices, and a proposed hybrid design are further discussed in U.S. patent application Ser. No. 10/875,832, filed Jun. 23, 2004, which is hereby incorporated by reference in its entirety. Charts provide another means of presenting data that typically does not include the column/row format. Charts instead present data graphically, such as in the well-known pie chart for showing percentages of a total.

In light of the current state of the data reporting industry, there is a heretofore unrecognized need to provide additional flexibility and simplicity in supporting the control of properties presented in data structures.

### SUMMARY OF THE INVENTION

In consideration of the above-identified shortcomings of the art, the present invention provides systems and methods for controlling report properties based on aggregate scope. A plurality of scope declarations can be provided to delineate various portions of any data structure, such as a matrix, a table, or a chart. Some scope declarations may correspond to portions of a horizontal axis, or columns, while other scope declarations may correspond to portions of a vertical axis, or rows. Thus, the aggregate scope at any given location within a data structure may vary, depending on which scope declarations overlap at the given location. Properties can be set for a location of a data structure based on this aggregate scope, thereby providing increased control flexibility. Other advantages and features of the invention are described below.

### BRIEF DESCRIPTION OF THE DRAWINGS

The systems and methods for controlling report properties based on aggregate scope in accordance with the present invention are further described with reference to the accompanying drawings in which:

FIG. 1a illustrates a prior art matrix that allows for control of properties on a column-by-column or row-by-row basis. Designers can specify whether a row property or a column property will override in the event of a conflict, which provides some limited property control flexibility.

FIG. 1b illustrates a typical prior art arrangement for report processing software in which a report definition is combined with data to produce an output report.

FIG. 2a is a block diagram broadly representing the basic features of an exemplary computing device suitable for use in conjunction with various aspects of the invention;

FIG. 2b is a block diagram representing a more detailed exemplary computing device suitable for use in conjunction with various aspects of the invention;

FIG. 2c illustrates an exemplary networked computing environment in which may computerized processes, including those of the invention, may be implemented;

FIG. 3 illustrates report processing software that can calculate an aggregate scope for locations in a report. Results can be saved to a scope log to avoid unnecessarily repeating the calculation. Having calculated aggregate scopes, the report processing software can apply any specified properties to the various locations.

FIG. 4 illustrates a matrix with axes portions that have been given exemplary scope declarations. The various locations within the matrix are of varying scopes, depending on which portions overlap at any given location.

FIG. 5 identifies the aggregate scope of the various locations within the matrix of FIG. 4. For example, all locations labeled “PH” in FIG. 4 have an aggregate scope that includes all of the portions with declared scopes in FIG. 4. The location labeled “M,” however, has an aggregate scope that falls outside all of the portions with declared scopes.

FIG. 6 provides a flow chart that demonstrates some of the properties of data structures that may be conveniently controlled based on aggregate scope.

FIG. 7 provides exemplary pseudo-scope declarations corresponding to the various scope declarations graphically illustrated in FIG. 4 and FIG. 5.

### DETAILED DESCRIPTION OF ILLUSTRATIVE EMBODIMENTS

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

This detailed description generally explains and expands upon the concepts introduced in the summary of the invention, above. First, a reporting data structure, as that term is used here, is defined. Next is a discussion of exemplary report processing software that can implement the techniques of the invention. Following is a discussion of scope declarations that can correspond to regions of a reporting data structure, and of how scope declarations can be combined to determine an aggregate scope. Next is a discussion of various exemplary properties that can be controlled based on aggregate scope in a data structure. Finally, a suitable computing and network environment is illustrated for use with the systems and methods provided herein.

Exemplary Reporting Data Structures

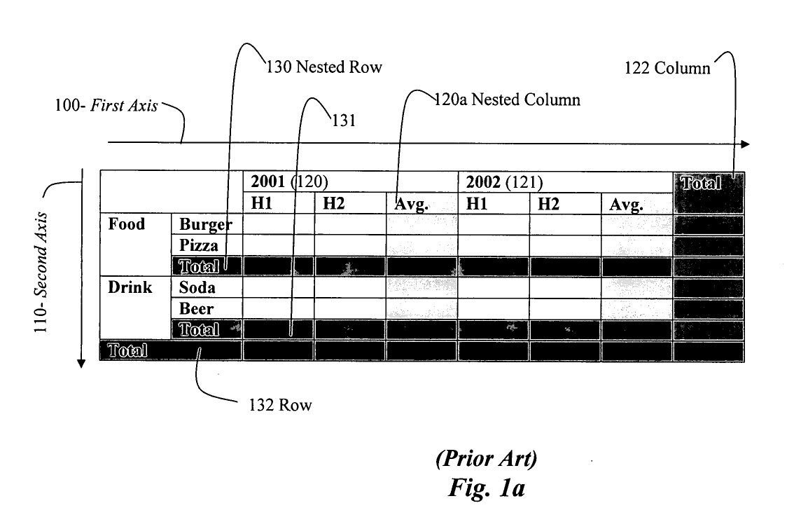

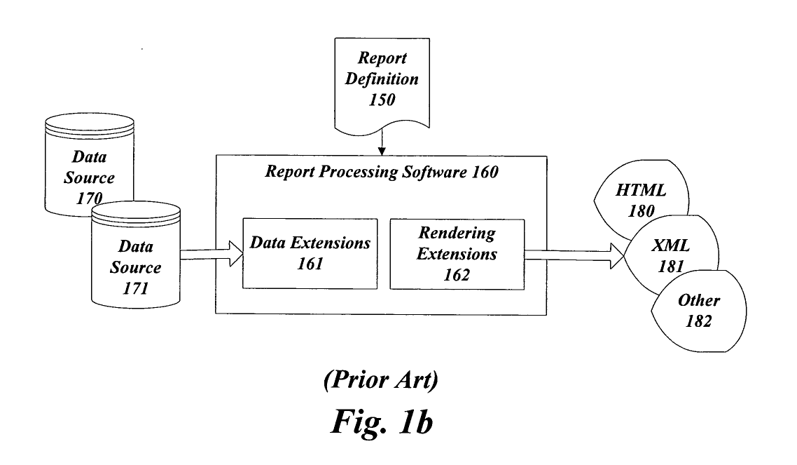

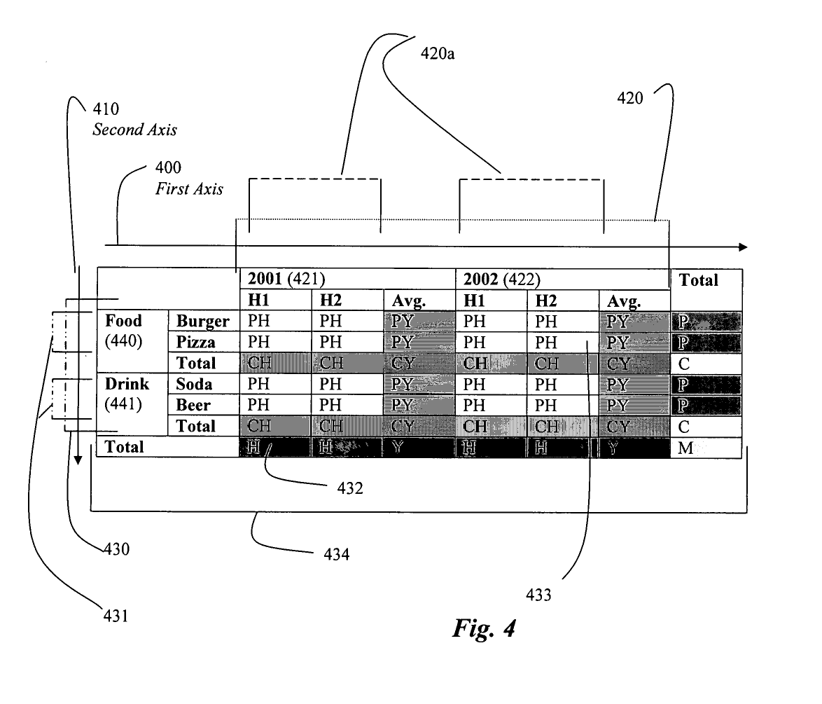

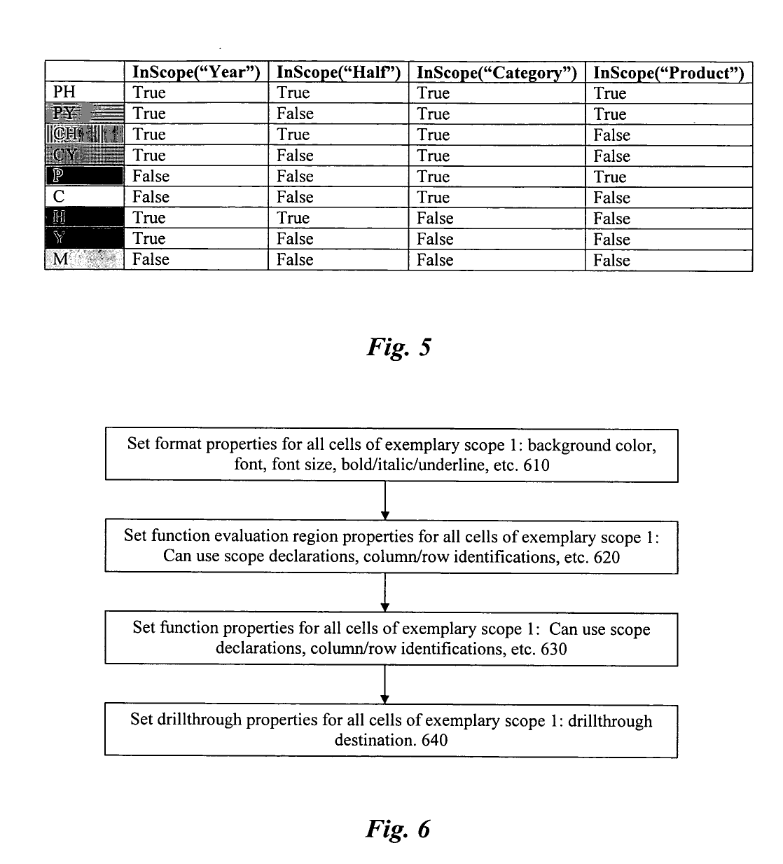

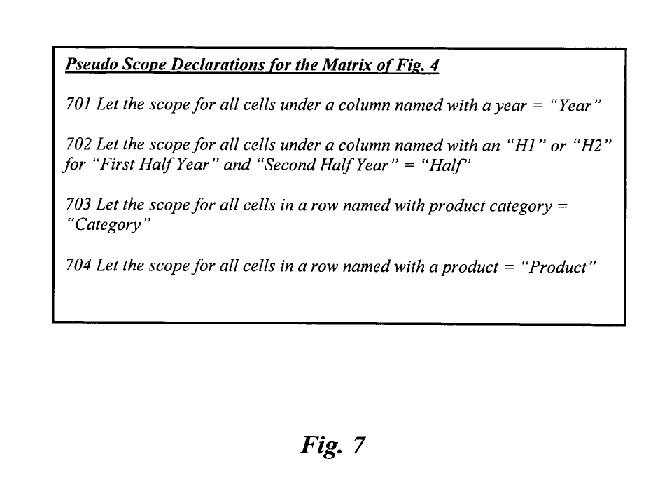

A report is typically a compilation of data for display in columns and rows on a visual surface. Reports may also comprise charts, which graphically present data without columns and rows, as in the familiar pie chart. The data in a report can be any data. A typical report may include financial data for an enterprise, such as gross revenue for the sales of various products, expenses associated with various products, profits associated with various products, and the like. Other reports may include customer information, such as names, contact information including telephone numbers, addresses, and email addresses, as well as product preferences, gross annual purchases, special discounts, and so on. A report may also be used to track employees, by compiling employee names, hours worked, accomplishments, scheduled vacation time, special needs, etc. These examples are a very small subset of the possible data that may be included in a report. Any data that humans may desire to compile regarding any endeavor can be placed in a report. FIG. 1 shows a typical prior art matrix data structure for a report, while FIG. 4 shows a similarly formatted matrix that implements various techniques of the invention. The reports in the figures display somewhat less data than the typical report, for ease of illustration. A more typical report may include tens, hundreds, or thousands of rows and columns, as necessary to display all the data for a report.

Reports may include a variety of data structures. An example of one such structure, a matrix, is provided in FIG. 1a. A matrix is characterized by columns arranged along a horizontal first axis 100 and rows arranged along a vertical second axis 110. These columns and rows can be dynamic or static. Static columns and rows are characterized by a one-to-one relationship between the report definition and the output report. Dynamic columns and rows are abstractly identified in a report definition, such that they can be expanded as necessary by report generating software to adequately present greater or lesser amounts of report data. For example, as time goes on, the data in columns 120 and 121 may expand to include subsequent years 2003 and 2004. Additional columns can be added automatically to provide such additional data. This allows report designers to re-use a single report definition from year to year.

A matrix data structure can contain nested column/row groups, such as the “burger” and “pizza” products from FIG. 1a that are nested in the “food” category. A matrix data structure can also contain header and footer columns and rows. For example, FIG. 1a gives a header row with column identifiers such as 120 and 121, and a footer row for grand totals at the bottom row of the matrix. In addition, nested footers in FIG. 1a provide subtotals within each category. These header and footer rows typically, but not necessarily, contain some information that is different from the non-header/footer rows, and that serves to describe or summarize the data in the non-header/footer rows.

Other examples of data structures that may be used in reports are tables and charts. Tables can be visualized as quite similar to the matrix format shown in FIG. 1 and FIG. 4. While a matrix has an empty corner cell, typically in the top left of the matrix, a table has not such empty corner cell. Thus, a traditional table is simpler than a matrix, in that rows may be static or dynamic, but columns are only static. Charts provide another means of presenting data that typically does not include the column/row format. Charts instead present data graphically, such as in the well-known pie chart for showing percentages of a total.

While tables and charts present different properties from matrices that may affect some aspects of implementations of the invention, it should be emphasized that embodiments of the invention can be modified to control properties of tables and even some charts based on aggregate scope. A matrix provides the best illustration of many features of the invention and is therefore used as a primary example here.

A report may be divided into regions, and the various regions of a report may be designed according to differing report definitions. Further, a single report definition may specify various regions within a report that follow different definitions. This potential feature of reports is explained in greater detail in U.S. patent application Ser. No. 10/400,734. For the purpose of this document, the term report should be construed to mean both an entire and complete report, or a region of a report that conforms to a particular set of design choices.

Reporting data structures that are considered appropriate for use with various embodiments of the invention have several salient characteristics. These characteristics can be observed with reference to FIG. 4. First, data structures are organized along a plurality of axes, such as first axis 400 and second axis 410. A typical reporting data structure is limited to two axis, because it is presented on paper or on a two dimensional display screen. However, it is commonly understood in the art that data, such as the data in a database, can be stored in n dimensions. While visually representing such data to a human viewer may become difficult or even impossible as the number of axes increases above three, digitally stored reports with n axes are feasible in the art, and as such the systems and methods provided herein can be used with reporting data structures that organize data along any number or axes.

Second, coordinates along the axes of a reporting data structure correspond to locations, or regions, within the data structure. Thus, a column, e.g., 421, in the matrix of FIG. 4 spans a range of coordinates along a horizontal axis 400. Column 421 thus corresponds to a region of the matrix comprising all of the space beneath its horizontal axis 400 range. Similarly row 440 spans a range of coordinates along the vertical axis 410. Row 440 thus corresponds to a region of the matrix comprising all of the space to the right of its vertical axis 410 range.

Locations in reporting data structures can thus be defined by coordinates along any of the axes. A location can be a region as large as the entire reporting data structure itself, if the location is defined by the entire range of coordinates along each of the axes. Typically the smallest location in a report is that of a single cell. The single cell is defined by a set of coordinates corresponding to a single innermost column, which may be a nested column such as columns H1 and columns H2 in FIG. 4, and a single innermost row, which may be a nested row such as the “Burger” and “Pizza” rows of FIG. 4.

A characteristic of data structures contemplated for use with various embodiments of the invention is the presence of columns and rows. A column of a report is a vertical band in which related report data is located. A column may be identified by a column heading in a top row of a column. A column may be divided into subgroups of columns, which may themselves be further be divided into subgroups down to any level of subgrouping. Therefore, a first column for “cars” may be divided into FORD® and TOYOTA® subgroups. Each of these columns may be further divided into model subgroups, such as FOCUS®, TAURUS®, and BRONCO® in the FORD® column and CAMRY®, COROLLA®, and TERCEL® in the TOYOTA® column. Each of these model columns may be further divided into colors, such as red, blue, and green. The further division of columns may continue as necessary to any level of subgrouping. Each of these columns, whether a top-level column or a column that exists at some level of subgrouping, is referred to here as a column. Where necessary for the purpose of discussion, the term subgroup column, nested column or the like will be used to point out the appropriate feature of a column.

Similarly, a row of a reporting data structure is a horizontal band in which related report data is located. A row may be identified by a row heading in a first column of a row. A row may be divided into subgroups of rows, which may themselves be further be divided into subgroups down to any level of subgrouping. Therefore, a first row for “cars” may be divided into FORD® and TOYOTA® subgroups. Each of these rows may be further divided into model subgroups, such as FOCUS®, TAURUS®, and BRONCO® in the FORD® row and CAMRY®, COROLLA®, and TERCEL® in the TOYOTA® row. Each of these model rows may be further divided into colors, such as red, blue, and green. The further division of rows may continue as necessary to any level of subgrouping. Each of these rows, whether a top-level row or a row that exists at some level of subgrouping, is referred to here as a row. Where necessary for the purpose of discussion, the term subgroup row, nested row, or the like will be used to point out an appropriate feature of a row.

A report definition is a template for a report that shows what data will be displayed in an actual report and the format of the data. A report definition can comprise a computer readable set of instructions in a proper computer readable syntax, such as XML or HTML. Such a definition may also be embodied graphically. In the case of a graphically represented report definition, report definition software is typically used as an aid in supplying report definition parameters and generating a report definition file.

Report definition software typically uses a GUI for graphically representing a report definition. For example, report definition software may present a designer with a number of empty columns and rows on a computer screen GUI. A designer may select any of the various columns and rows using a mouse or other control device. A designer may then enter data that is desired for a report by selecting from a plurality of menu options, or by identifying the data directly through typing identification information with a keyboard input. The information that a report designer enters using various input devices may then be stored in a report definition file. This file provides a compact representation of the report definition created by a report designer, and may be in any number of file formats, e.g., XML, HTML, .txt, .doc, etc.

Exemplar Report Processing Software

A report definition, whether generated directly or with the aid of report definition software, can be used by report processing software to generate an actual report. This process generally entails populating the appropriate columns and rows indicated in a report definition with appropriate data. If a report definition describes data structure such as a chart that does not have columns and rows, some report processing software may be able to generate the appropriate graphical representation as well.

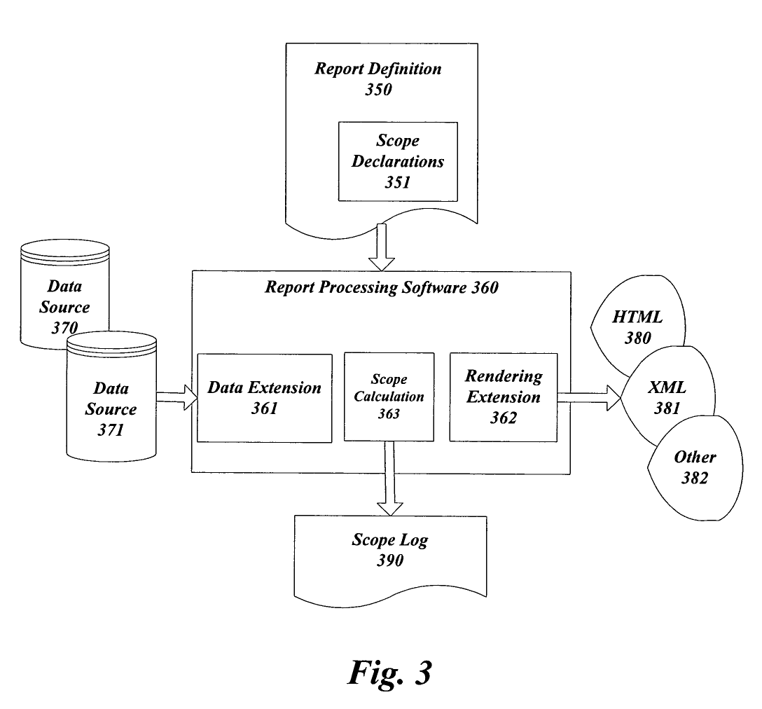

Report processing software includes any software for compiling a report from a report definition. FIG. 3 displays aspects of report processing software 360 suitable for use with embodiments of the invention. Such software 360 performs the function of querying a data source 370, 371 to retrieve data that is specified in a report definition 350. One or more data extensions 361 may be used to properly interpret data from a data source 370, 371. The software 360 then compiles the retrieved data into a layout specified by the report definition 350. The output report may be rendered into any file format, e.g., 380, 381, 382 using one or more rendering extensions 362. Those of skill in the art will acknowledge that separate software components, such as objects created in a language that supports object oriented programming, can be used to perform the various functions of report processing software 360.

FIG. 3 illustrates that a report definition 350 for use with the invention may comprise a plurality of scope declarations 351. Scope declarations 351 will be described in detail below. For the purpose of this discussion, scope declarations are computer readable location identifiers for a portion of an axis of a reporting data structure. For example, a scope declaration can declare a first location, defined by a hypothetical second and third columns of a matrix, to be identified as location “foo.” One can imagine a vertical band of scope “foo” corresponding to a second and third column. A second location, defined by a hypothetical fourth and fifth row of a matrix, could be identified with a scope declaration as location “bar.” One can imagine a horizontal band of scope “bar” corresponding to a fourth and fifth row. In this situation, the location defined by the overlap of the “foo” scope location and the “bar” scope location has an aggregate scope of “foo-bar,” in that such a location is within these two scopes.

Scope declarations 351 can be included with a report definition 350 in various embodiments. Such embodiments present the advantage of a compact representation for a report definition 350 that does not span several files. However, it will be recognized that scope declarations 351 need not be included in the same file as 350. Instead, report processing software 360 may combine a set of scope declarations stored in a separate file with a report definition. Such embodiments allow re-use of scope declaration files, which may be useful in some settings. Another option is for report processing software 360 to contain a set of default scope declarations that are used for all report definitions that fit a predefined set of parameters. FIG. 3 illustrates that scope declarations 351 may be used by report processing software 360 along with a report definition, and is not intended to limit the invention to a particular location for the scope declarations 351.

The scope declarations 351 may be processed by a scope calculation process 363 that may operate in connection with the report processing software 360. The scope calculation process 363 can determine the aggregate scopes for locations within a report data structure. Various techniques for accomplishing this calculation are possible. One example of such techniques is a simple walk-through. The scope calculation process 363 can walk through the cells of a matrix, and determine an aggregate scope at each cell. For example, with reference to FIG. 4, when the process 363 arrives at the first cell in the “burger” row, the process 363 can determine that the cell is within scopes “Year” and “Half” from the vertical axis, and within scopes “Category” and “Product” from the horizontal axis. The location can be identified as of scope PH. With reference to FIG. 5, scope PH identifies locations within all four available scopes, plus a default Matrix scope (not shown in FIG. 5).

Consider a matrix that has a year column grouping and a product row grouping, with a subtotal on each, such as that of FIG. 4. If the value of a textbox in a detail cell is =Sum(Fields!Sales.Value), each detail cell will be grouped on both year and product. However, the year subtotal will only be grouped on product and the product subtotal will only be grouped on year (and the grand total will not be grouped on either). This is the problem presented in the background section. The scope calculation process 390, also called “InScope,” can be used to determine what the current instance should be grouped on:

| Function | Arguments | Type | Description |
|---|---|---|---|
| Functions.InScope | Return | Boolean | True if the current instance |
| or InScope | | | is within the specified |
| | | | scope |
| | Scope | String | Name of a DataSet, |
| | | | Grouping or DataRegion |

Referring again to FIG. 5, it can be seen that the data presented there serves as an exemplary result set for a scope calculation process operating on the report of FIG. 4. As will be discussed below, the scope calculation process may also be useful in setting a variety of properties that may vary throughout a report data structure. For example, one typical usage for the scope calculation process 390 is to construct links to drillthrough reports:

```
<Drillthrough>
    <ReportName>=iif(InScope(“Month”),”Transactions”,
    ”ProductTotByYear”)</ReportName>
        <Parameters>
            <Parameter Name=Year>
                <Value>=Fields!Year</Value>
                <Omit>=Not(InScope(“Year”))</Omit>
            </Parameter>
            <Parameter Name=Month>
                <Value>=Fields!Month</Value>
                <Omit>=Not(InScope(“Month”))</Omit>
            </Parameter>
            <Parameter Name=Product>
                <Value>=Fields!Product</Value>
                <Omit>=Not(InScope(“Product”))</Omit>
            </Parameter>
        </Parameters>
</Drillthrough>
```

The aggregate scope for each location may be saved to a scope log 390. The scope log 390 allows the scope calculation process 363 to avoid recalculating the scopes for various locations within a report. The scope log 390 may be stored in a cache memory on a computing device. When properties are identified for locations of a particular aggregate scope, the report processing software 360 may refer to the scope log 390 to identify the locations at which the properties should be provided. The report processing software may then cause the appropriate properties to be rendered at the appropriate locations.

Exemplary Scope Declarations and Aggregate Scope

FIG. 7 presents several pseudo scope declarations to illustrate this aspect of the invention. Scope declarations are computer readable location identifiers for a portion of an axis of a reporting data structure. In a matrix with columns and rows, a scope declaration may be any declaration that operates to categorize one or more rows or one or more columns. One powerful aspect of the invention is the severance of the scope categorization of columns and rows from the columns and rows themselves. Traditionally, a location in a report data structure was categorized by the columns and rows that it was located in. By severing the categorization from the columns and rows themselves, the invention allows for flexible and useful categorization of locations in a report, such that aggregate scopes can be used as a tool in setting report properties.

The scope declarations themselves can take a wide range of forms. Any unique computer readable identifier can serve as a scope declaration. A scope declaration is made by associating an identifier with either one or more rows or one or more columns. For example, a first column or columns could be identified as “laskdfj” or “scope 1,” or “**.” The scope declaration, also called a scope identifier or simply an identifier, serves to create a category, which includes the associated set of columns or rows, and which is identified by the scope declaration. Any location in a data structure can then be identified by the sum of the overlapping categories, identified by any scope declarations, at that location. If there are no overlapping categories, a default category can be declared for the entire data structure, and the location may be identified by the default alone.

FIG. 4 provides a matrix with various identifiers that serve as scope declarations. The identifiers themselves are not shown in FIG. 4. Instead, brackets 420a, 420, 430, 431 are provided to indicate the columns or rows that are identified in this example. Note that a designer can provide an identifier for any columns and any rows as he sees fit. The decision regarding which columns and or rows to provide identifiers will affect the aggregate scope, a sum of the overlapping identifiers, at the various locations within a data structure. In the example of FIG. 4, the aggregate scope at each location in the data structure has been noted by symbols that are described in FIG. 5.

Exemplary identifiers for the bracketed locations in FIG. 4 could be as follows: locations 420 may be declared to be scope=Year. These columns 420 are in the Year scope. Locations 420a may be declared to be scope=Half. These columns 420a are in the Half Year scope. Locations 430 may be declared to be scope=Category. These rows 430 are in the Category scope. Locations 431 may be declared to be scope=Product. These rows 431 are in the Product scope. Finally, the entire matrix of FIG. 4 can be declared to be scope=Matrix. All locations in the matrix are thus of the Matrix scope. Note that because this is the default scope, this feature of the various aggregate scopes is not reflected in FIG. 5 (it would be “true” for all aggregate scopes).

FIG. 4 shows how the various identifiers associated with locations, such as columns or rows, in a data structure can combine within the data structure to provide a fabric of overlapping identifiers. Aggregate scope PH is reflected at various places in the matrix, aggregate scope Y occurs at other locations, and so on. By assigning scope identifiers to the various logical regions of a data structure, a designer can create such a fabric with any desired variation in features across the locations of the matrix. The various aggregate scopes can be used to assign properties, providing greater flexibility than the row-by-row, or column-by column method.

FIG. 7 provides exemplary pseudo-scope declarations 701, 702, 703, and 704. These pseudo-scope declarations 701, 702, 703, and 704 operate by identifying columns and rows that are within a declared scope. For example, scope declaration 701 provides “Let the scope for all cells under a column named with a year=“Year”.” Scope declaration 701 thus identifies a type of column, namely, one with a column heading that gives a year, and provides that any such column falls within the declared “Year” scope. Similarly, scope declarations 702, 703, and 704 identify column or row types and declare them within the provided scopes. Scope declarations 701, 702, 703, and 704 could just as well declare scopes using some other method. For example, a scope declaration could simply provide “Let column 1 be in scope 1.” This declaration simply identifies a first column in a report data structure and declares it within a scope 1. A scope declaration could also provide “Let every even numbered column be in scope 1,” “Let any column that falls within a 3 inch mark and 6 inch mark on the horizontal axis be in scope 1,” or “Let any column that is wider than 2 inches be in scope 1.” These examples are intended to illustrated the wide range of parameters that can be used to define a scope for the purposes of a scope declaration.

The scope declarations should be readable by the report processing software 360. In this regard, it may be preferable to provide the scope declarations in an appropriate syntax, such as the Extensible Markup Language (XML). In various preferred embodiments, a report definition language can be devised in XML to standardize the syntax used to identify properties of reports and scope declarations. Other markup languages such as Hyper Text Markup Language (HTML) WORD® Markup Language (WordML), and so on are also suited for use in providing scope declarations.

Using the various scope declarations provided for a report data structure, a scope calculation process 390 can calculate an aggregate scope for all locations within the data structure. Aggregate scope is an accumulation of all declared scopes for a particular location. Thus if there are 5 scope declarations along a horizontal axis that overlap over a particular location, and there are two scope declaration along a vertical axis that overlap at the same particular location, the aggregate scope for that particular location is the combination of all seven overlapping scopes.

FIG. 5 in conjunction with FIG. 4 is helpful in illustrating the concept of aggregate scope. FIG. 5 provides a plurality of aggregate scope identifiers on the left. Each aggregate scope identifier is described by whether it is “inscope” for the various scope declarations made in FIG. 4. These aggregate scope identifiers are then placed in the cells of FIG. 4 to indicate the aggregate scope of the various locations in FIG. 4. As can be surmised from FIG. 4, if a property is assigned to all locations of a particular scope, significant control flexibility is attained that was not formerly achievable in this simple, straightforward manner.

Exemplary Properties Controlled Based on Aggregate Scope

Any property of a report data structure can be controlled based on the aggregate scope of a location. While typically control over a property of a location may be beneficially based on the aggregate scope of the location, aggregate scope of one location my also be used to control properties of other locations of a report as a whole. FIG. 6 presents a number of properties that may be beneficially controlled using the aggregate scope techniques herein.

A first candidate for properties to control based on aggregate scope are formatting properties such as background color, font, font size, bold/italic/underline, etc. 610. These are properties that frequently vary within a row such as a subtotal row, and using aggregate scope this variation can be categorized and controlled. A second candidate for properties to control based on aggregate scope are function evaluation region properties 620. A function in a cell of a report data structure is typically evaluated with reference to a region of the report, rather than with reference to the report as a whole. Thus, in FIG. 4, the subtotal rows calculate sums for only the appropriate cells. This evaluation region is a property that may be varied based on aggregate scope. Moreover, the scope declarations themselves may serve to define the function evaluation regions. Thus the scope declarations can serve a dual purpose.

A third candidate for properties to control based on aggregate scope are function properties. A location of a report may contain any number of functions, and it may be desirable to vary these functions within a row or column. Recall that previously this was done though a less convenient process of specifying property overrides. Now a function can be specified for a particular aggregate scope, and placed in all locations where that aggregate scope is present. Below is a non-limiting list of “aggregate functions” that may be placed in a location based on that location's aggregate scope:

| Function | Arguments | Type | Description |
|---|---|---|---|
| Sum | Return | Float | Returns the sum of all values of the expression |
| | | | within the scope |
| | | | Return type is decimal for decimal expressions and |
| | | | double for all other expressions |
| | Expression | Integer or | The expression to aggregate. Cannot contain any |
| | | Float | aggregate functions. |
| | Scope | String | Name of a DataSet or the name of a Grouping or |
| | | | DataRegion that contains (directly or indirectly) |
| | | | the report item that the aggregate function is used |
| | | | in. Indicates the aggregate should apply to the |
| | | | entire data set, all of the data in the current group, |
| | | | or all of the data in the current data region. May |
| | | | only be a constant, not an expression. |
| Avg | Return | Float | Returns the average of all nonnull values of the |
| | | | expression within the scope |
| | | | See Sum regarding return type |
| | Expression | Integer or | See Sum |
| | | Float | |
| | Scope | String | See Sum |
| Max | Return | Variant | Returns the maximum of all nonnull values of the |
| | | | expression within the scope |
| | | | Return type is the same as the expression type. |
| | Expression | Variant | See Sum |
| | Scope | String | See Sum |
| Min | Return | Variant | Returns the minimum of all nonnull values of the |
| | | | expression within the scope |
| | | | Return type is the same as the expression type. |
| | Expression | Variant | See Sum |
| | Scope | String | See Sum |
| Count | Return | Integer | Returns the count of all nonnull values of the |
| | | | expression within the scope |
| | Expression | Variant or | See Sum |
| | | Binary | |
| | Scope | String | See Sum |
| CountDistinct | Return | Integer | Returns the count of all distinct nonnull values of |
| | | | the expression within the scope |
| | Expression | Variant | See Sum |
| | Scope | String | See Sum |
| CountRows | Return | Integer | Returns the count of all rows within the scope |
| | | | Syntax: “CountRows(Scope)” |
| | Scope | String | See Sum |
| StDev | Return | Float | Returns the standard deviation of all nonnull |
| | | | values of the expression within the scope |
| | Expression | Integer or | See Sum |
| | | Float | |
| | Scope | String | See Sum |
| StDevP | Return | Float | Returns the population standard deviation of all |
| | | | nonnull values of the expression within the scope |
| | | | Return type is the same as the expression type. |
| | Expression | Integer or | See Sum |
| | | Float | |
| | Scope | String | See Sum |
| Var | Return | Float | Returns the variance of all nonnull values of the |
| | | | expression within the scope |
| | | | See Sum regarding return type |
| | Expression | Integer or | See Sum |
| | | Float | |
| | Scope | String | See Sum |
| VarP | Return | Float | Returns the population variance of all nonnull |
| | | | values of the expression within the scope |
| | | | See Sum |
| | Expression | Integer or | See Sum |
| | | Float | |
| | Scope | String | See Sum |
| First | Return | Variant or | Returns the first value of the expression within the |
| | | Binary | scope (after all sorting has been applied) |
| | | | Return type is the same as the expression type. |
| | Expression | Variant or | See Sum |
| | | Binary | |
| | Scope | String | See Sum |
| Level | Return | Integer | Returns a 0-based integer representing the current |
| | Scope | String | depth level of a recursive hierarchy. |
| | | | If the scope does not exist, specifies a dataset or |
| | | | dataregion (which cannot have parents), or |
| | | | specifies a grouping without a parent, returns 0. |
| | | | If Scope argument is omitted, defaults to the |
| | | | current scope. |
| Last | Return | Variant or | Returns the last value of the expression within the |
| | | Binary | scope (after all sorting has been applied) |
| | | | Return type is the same as the expression type. |
| | Expression | Variant or | See Sum |
| | | Binary | |
| | Scope | String | See Sum |
| Previous | Return | Variant or | Returns the value (or aggregate value) of the |
| | | Binary | expression for the previous instance of the |
| | | | PreviousScope within the AggScope (after all |
| | | | sorting has been applied). |
| | | | Return type is the same as the expression type. |
| | Expression | Variant or | See Sum |
| | | Binary | |
| | AggFunction | Enum | Optionally specifies the aggregate value to return. |
| | | | Must be specified if AggScope is specified. Can be |
| | | | omitted for detail scope. Unlike RunningValue, the |
| | | | previous aggregate does not reset within |
| | | | reportitems between scope instances of the top- |
| | | | level data region. |
| | PreviousScope | String | Should be a containing scope of the current scope. |
| | | | Previous returns null if the specified scope is a |
| | | | data region or data set. If Ommited, defaults to |
| | | | current scope. |
| | AggScope | String | Should be a containing scope of the current scope. |
| | | | Should be should be contained within or same as |
| | | | PreviousScope. And they should both be the |
| | | | containing scope of the current scope. |
| | | | If omitted, it defaults to PreviousScope |
| RunningValue | Return | See Function | A running aggregate of the expression, using the |
| | | | specified aggregate function. |
| | Expression | See Function | The expression to aggregate. Cannot contain any |
| | | | aggregate functions. |
| | Function | Enum | Name of an aggregate function for which to |
| | | | calculate a running value (Cannot be CountRows, |
| | | | RunningValue, RowNumber or Aggregate). |
| | | | Expression type and Return type are determined |
| | | | by the aggregate function used. |
| | Scope | String | Name of a DataSet or the name of a Grouping or |
| | | | DataRegion that contains (directly or indirectly) |
| | | | the report item that the aggregate function is used |
| | | | in. Indicates the running value doesn't reset for the |
| | | | entire data set, resets whenever the group |
| | | | expression changes, or resets with each new |
| | | | instance of the data region. May only be a |
| | | | constant, not an expression. |
| RowNumber | Return | Integer | Equivalent to RunningValue(*, Count, Scope) |
| | Scope | String | See RunningValue |
| Aggregate | Return | Determined | Calcuates a custom (data provider defined) |
| | | by data | aggregate for the expression at the given scope. If |
| | | provider | the data provider does not support this function or |
| | | (see | if the data is not available for the given expression |
| | | Field.Value) | or scope, Nothing is returned. |
| | Expression | N/A | The expression to aggregate. |
| | | | Must be a simple field reference |
| | | | (e.g., =Aggregate(Fields!Sales.Value, Year) |
| | Scope | String | See Sum |
| | | | All group expressions for the Scope (and all |
| | | | containing grouping scopes) must be simple field |
| | | | references |

Recursive

“Recursive” can be an optional final argument for each of the aggregate functions above. Type: Enum (Recursive|Simple). Default: Simple. “Recursive” indicates that the aggregate function should apply to all data in the current instance of the given scope and all descendant instances of the current instance. “Recursive” is ignored if a scope has no Parent property.

A final exemplary property that may be set based on aggregate scope value for a location is the drillthrough property 640. Drillthrough properties allow a report consumers to jump from one location to another. For example, a cell of a report may allow a consumer to jump to another report that provides supplementary data, or to a description of the data in the cell. Drillthrough properties are properties that frequently vary within a cell or column, and are thus good candidates for use with the more flexible aggregate scope property control techniques provided by the invention.

Exemplary Computing and Network Environment

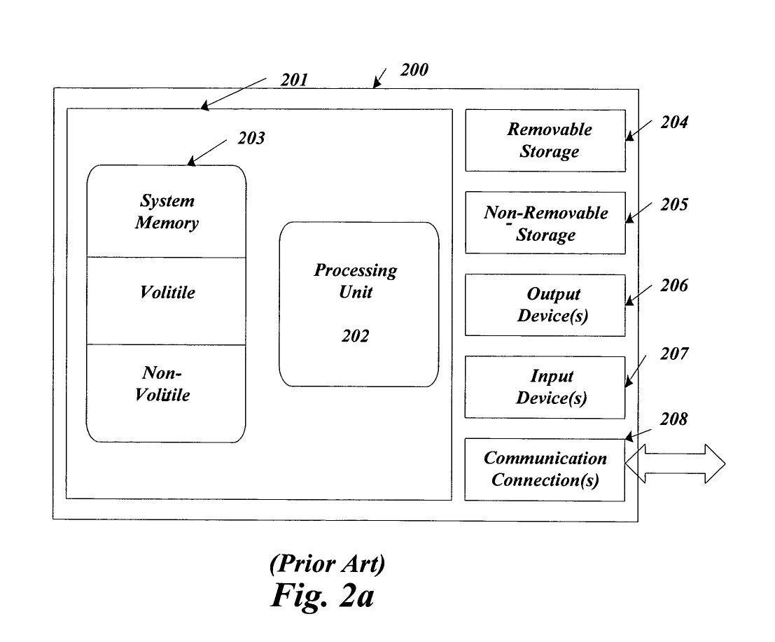

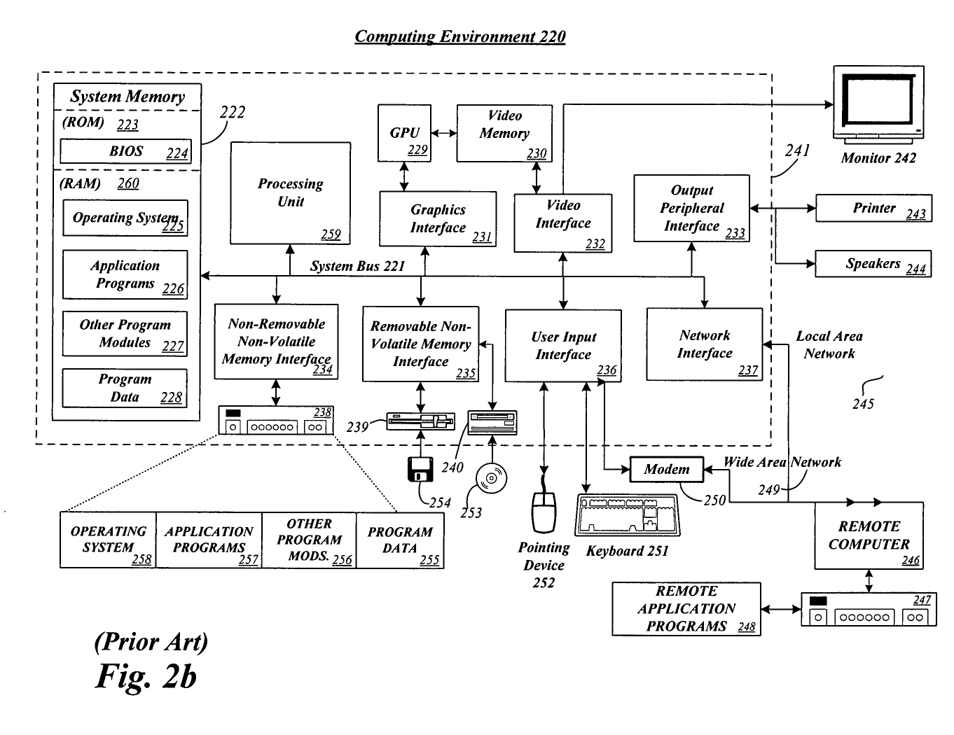

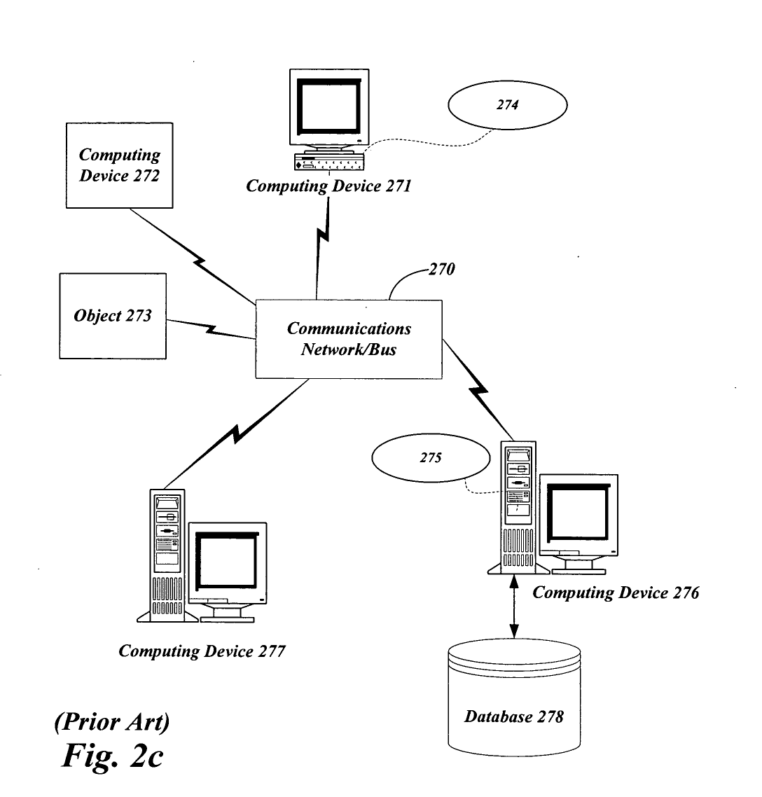

With reference to FIG. 2a, an exemplary computing device 200 suitable for use in connection with the systems and methods of the invention is broadly described. In its most basic configuration, device 200 typically includes a processing unit 202 and memory 203. Depending on the exact configuration and type of computing device, memory 203 may be volatile (such as RAM), non-volatile (such as ROM, flash memory, etc.) or some combination of the two. Additionally, device 200 may also have mass storage (removable 204 and/or non-removable 205) such as magnetic or optical disks or tape. Similarly, device 200 may also have input devices 207 such as a keyboard and mouse, and/or output devices 206 such as a display that presents a GUI as a graphical aid accessing the functions of the computing device 200. Other aspects of device 200 may include communication connections 208 to other devices, computers, networks, servers, etc. using either wired or wireless media. All these devices are well known in the art and need not be discussed at length here.

FIG. 2b illustrates a somewhat more detailed example of a suitable computing device from FIG. 2a and peripheral systems. The computing system environment 220 is only one example of a suitable computing environment and is not intended to suggest any limitation as to the scope of use or functionality of the invention. Neither should the computing environment 220 be interpreted as having any dependency or requirement relating to any one or combination of components illustrated in the exemplary operating environment 220.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be implemented in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2b, an exemplary system for implementing the invention includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 1 illustrates operating system 225, application programs 226, other program modules 227, and program data 228.

The computer 241 may also include other removable/non-removable, volatile/nonvolatile computer storage media. By way of example only, FIG. 1 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 2b, provide storage of computer readable instructions, data structures, program modules and other data for the computer 241. In FIG. 2b, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 2b. The logical connections depicted in FIG. 2b include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 2b illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments refer to utilizing the present invention in the context of one or more stand-alone computer systems, the invention is not so limited, but rather may be implemented in connection with any computing environment, such as a network or distributed computing environment. Still further, the present invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

An exemplary networked computing environment is provided in FIG. 2c. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 2c provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 2c, and may itself represent multiple interconnected networks. In accordance with an aspect of the invention, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2c, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework of provided in FIG. 2a and FIG. 2b, and the further diversification that can occur in computing in a network environment such as that of FIG. 2c, the systems and methods provided herein cannot be construed as limited in any way to a particular computing architecture. Instead, the present invention should not be limited to any single embodiment, but rather should be construed in breadth and scope in accordance with the appended claims.

What is claimed:

1. A computer readable medium bearing instructions for generating a report, comprising:
instructions for retrieving data specified in a report definition file from a data source;
instructions for formatting said data into a plurality of columns; instructions for associating a first identifier with at least one column;
instructions for associating a second identifier with said at least one column;
instructions for determining an aggregate scope for a location within said at least one column, wherein the aggregate scope comprises a sum of identifiers associated with said column; and
instructions for identifying at least one property corresponding to the aggregate scope.

2. The computer readable medium of claim 1, wherein the at least one property comprises an evaluation region for a function that returns a value for display in the location.

3. The computer readable medium of claim 2, wherein the evaluation region is described using said first identifier.

4. The computer readable medium of claim 1, further comprising instructions for storing the aggregate scope in a scope log to avoid repeating said instructions for determining an aggregate scope.

5. The computer readable medium of claim 1, wherein the at least one property comprises a function that returns a value for display in the location.

6. The computer readable medium of claim 1, wherein the at least one property comprises a drillthrough property.

7. The computer readable medium of claim 1, wherein the at least one property comprises one or more of a text formatting property, a color formatting property, and a shading formatting property.

8. The computer readable medium of claim 1, wherein the format is a matrix format.

9. The computer readable medium of claim 1, wherein the format is a format for a region of a report.

10. A method for generating a report, comprising:
reading a report definition file that specifies a format for a plurality of columns, and data to be placed in the columns;
associating a first identifier at least one column;
associating a second identifier with said at least one column;
determining an aggregate scope for a location within the at least one column, wherein the aggregate scope comprises a sum of identifiers associated with said column.

11. The method of claim 10, further comprising identifying at least one property corresponding to the aggregate scope.

12. The method of claim 11, wherein the at least one property comprises one or more of a text formatting property, a color formatting property, and a shading formatting property.

13. The method of claim 11, wherein the at least one property comprises an evaluation region for a function that returns a value for display in the location.

14. The method of claim 13, wherein the evaluation region is described using one of said first and said second identifier.

15. The method of claim 11, wherein the at least one property comprises a function that returns a value for display in the location.

16. The method of claim 11, wherein the at least one property comprises a drillthrough property.

17. The method of claim 10, further comprising providing the at least one property to the location within said columns and rows.

18. The method of claim 10, wherein the format is a matrix format.

19. The method of claim 10, wherein the format is a format for a region of a report.

20. The method of claim 10, wherein report definition file comprises an Extensible Markup Language (XML) file.

21. The method of claim 10, further comprising storing the aggregate scope in a scope log to avoid repeating said determining an aggregate scope.

22. A means for generating a report, comprising:
means for reading a report definition filethat specifies a format for a plurality of columns, and data to be placed in the columns;
means for associating a first identifier at least one column;
means for associating a second identifier with said at least one column;
means for determining an aggregate scope for a location within the at least one column, wherein the aggregate scope comprises a sum of identifiers associated with said column.

23. The means for generating a report of claim 22, further comprising identifying at least one property corresponding to the aggregate scope.

24. The means for generating a report of claim 23, wherein the at least one property comprises one or more of a text formatting property, a color formatting property, and a shading formatting property.

25. The means for generating a report of claim 23, wherein the at least one property comprises an evaluation region for a function that returns a value for display in the location.

26. The means for generating a report of claim 23, wherein the at least one property comprises a function that returns a value for display in the location.

27. The means for generating a report of claim 23, wherein the at least one property comprises a drillthrough property.

28. The means for generating a report of claim 22, further comprising providing the at least one property to the location within said columns and rows.

29. The means for generating a report of claim 22, wherein the format is a matrix format.

30. The means for generating a report of claim 22, wherein the format is a format for a region of a report.

31. A computer readable medium bearing instructions for deriving at least one property of a data structure, comprising:
instructions for generating a data structure with a plurality of axes, including a first axis and a second axis;
instructions for processing a plurality of identifiers corresponding to at least one portion of at least one of said plurality of axes, wherein said at least one portion corresponds to at least one location of said data structure, and wherein said instructions for processing comprise instructions for correlating said plurality of scope declarations with said at least one location to calculate a a collection of overlapping identifiers associated with said at least one location.
